(19) United States
(12) Patent Application Publication
(10) Pub. No.: US 2016/0053572 A1
(43) Pub. Date: Feb. 25, 2016

(54) APPLYING COATING DOWNHOLE

(71) Applicant: SCHLUMBERGER TECHNOLOGY CORPORATION, Sugar Land, TX (US)

(72) Inventor: David Robert Evan SNOSWELL, Cambridge (GB)

(21) Appl. No.: 14/782,516

(22) PCT Filed: Apr. 2, 2014
(86) PCT No.: PCT/IB2014/060381

§ 371 Date: Oct. 5, 2015

(30) Foreign Application Priority Data
Apr. 4, 2013 (GB) 1306104.9

(51) Int. Cl. E21B 33/138; C09D 135/02

(52) U.S. Cl. CPC E21B 33/138; C09D 135/02

(57) ABSTRACT

Applying a photocurable coating to a downhole fixed surface surrounding the axis of a wellbore containing a wellbore fluid is carried out by skimming an applicator over the downhole surface while supplying a photocurable liquid composition between the applicator and the downhole surface thereby spreading the composition as a curable layer on the downhole surface, while providing a light output with a light-transmitting barrier facing and adjacent the curable layer on the downhole surface; and directing light of wavelength in a range from 100 nm to 1500 nm through the light-transmitting barrier onto the curable light-transmitting barrier so as to initiate curing of the layer on the downhole surface. The applicator may be an assembly comprising a belt or band of light-transmitting material and the light source may be positioned within the band or the loop of the belt. This portion of the belt can remain stationary in contact with the curable layer and separate from it by a peeling action.

### BACKGROUND

U.S. Pat. No. 7,931,091 disclosed a process for applying a fluid, photo curable, composition to the wall of an open hole wellbore, and curing the composition by illuminating it with electromagnetic radiation, referred to as actinic radiation and having a wavelength in a range spanning the ultra-violet, visible and near infra-red parts of the spectrum. Application of such coating can strengthen the wellbore wall. As pointed out in that document, by providing the radiation for solidifying or gelling the fluid composition in situ in the wellbore proximate to the region in which the solidified or gelled fluid composition is desired, more control over the lining of the wellbore is achievable. Thus, specific regions of a wellbore, e.g. cracked or fissured regions, can be lined or re-lined.

US patent application 2010/0247794 disclosed a similar process used to apply a photo curable composition to the interior of tubing which has been inserted into the wellbore in order to repair the tubing and prevent leakage, possibly after corrosion or damage to the tubing,

### SUMMARY

The present disclosure is also concerned with application of curable composition at a downhole location. This summary is provided to introduce a selection of concepts that are further described below. This summary is not intended to be used as an aid in limiting the scope of the subject matter claimed.

In a first aspect the present disclosure provides a method of applying a photocurable coating to a downhole surface surrounding the axis of a wellbore containing a wellbore fluid, the method comprising

placing a downhole tool with at least one applicator in the wellbore;

traversing the applicator over the downhole surface while supplying a photocurable liquid composition to enter between the applicator and the downhole surface thereby spreading the composition as a curable layer on the downhole surface;

providing a light output with a light-transmitting barrier facing and adjacent the curable layer on the downhole surface; and

directing light of wavelength in a range from 100 nm to 1500 nm through the light-transmitting barrier onto the curable layer so as to initiate curing of the layer on the downhole surface.

The applicator may travel close to, i.e. skim over, the downhole surface. Traversing the applicator over the downhole surface may be accompanied by movement along the wellbore so that the curable layer on the downhole surface is applied as a helix. This helix may have adjacent turns in contact with each other or overlapping so that multiple turns of the helical pattern provide a continuous coating.

The applicator may press the curable composition onto the downhole surface which will assist in spreading it as a coating layer which holds onto the downhole surface. Initiating photocuring with the curable layer located between the barrier and the downhole surface on which the layer has been spread assists in holding the layer onto the downhole surface during curing or at least the first part of curing.

The applicator and its operation may inhibit the presence of wellbore fluid (which may be opaque or strongly light absorbing) between the barrier and the curable layer in order to reduce or avoid loss of light as a result of absorption by the wellbore fluid and so allow more of the light to reach the curable layer to bring about photocuring. The configuration and operation of the applicator may inhibit entry of wellbore fluid between the barrier and the curable layer or may expel wellbore fluid which does enter between the barrier and the curable layer. One possibility is that the curable layer bridges the distance from the barrier to the downhole surface so that the barrier is in contact with the curable layer. In such an arrangement the material of the curable layer may exclude wellbore fluid from between the barrier and the curable layer. We have then found that using a material with a low-friction non-stick characteristic at the surface of the light-transmitting barrier mitigates adhesion of the curable composition to the barrier. Such a non-stick characteristic may be provided by a fluorocarbon at the surface of the light-transmitting barrier. The fluorocarbon may be a fluorocarbon polymer which may possibly be provided as a coating or may be used to form the barrier.

Another possibility is to introduce a layer of light-transmitting liquid, which does not undergo photocuring, between the barrier and the curable layer. This layer of liquid between the curable layer and the barrier can serve to prevent unwanted adhesion of the curable composition to the barrier. The combination of the curable layer and the layer of light transmitting liquid may bridge the distance from barrier to the downhole surface.

Even if a light transmitting liquid or a small amount of wellbore fluid is present between the barrier and the downhole surface, the curable layer may extend across more than half, possibly more than three quarters of the distance between the barrier and the downhole surface.

The light output may be one or more light sources positioned to direct light through the barrier, or may be the output end of one or more fibre optic cables (also termed light guides), carrying light from a light source elsewhere, the output end of the light guide(s) then being positioned to direct light through the barrier.

The downhole surface encircling the wellbore axis, to which the coating is applied, may be the wall of an open hole section of a wellbore, or may be the interior of tubing such as wellbore casing inserted into the wellbore.

In a second aspect there is disclosed here a wellbore tool for applying a photocurable coating to a downhole surface surrounding the axis of a wellbore wherein the tool comprises

at least one applicator comprising a light-transmitting barrier to face a downhole surface surrounding the wellbore tool;

means to move the applicator over the downhole surface;

means to deliver a photocurable liquid composition between the applicator and the downhole surface, and

at least one light output configured to direct light of wavelength in a range from 100 nm to 1500 nm through the light transmitting barrier towards the downhole surface.

A wellbore tool may include a reservoir for a supply of curable composition, along with a pump for delivering composition from the reservoir to enter between the applicator and the downhole surface. Possibilities for delivery of the composition include delivery through one or more apertures in an applicator surface facing the said downhole surface and delivery through a separate conduit positioned to deliver the composition close to the downhole surface just ahead of the applicator skimming the downhole surface.

The downhole tool may be configured to inhibit the presence of wellbore fluid between the light transmitting barrier and the downhole surface, as mentioned above.

The downhole tool may have a plurality of applicators. It may comprise means to move the applicator or each one of the applicators radially outwardly to an operative position proximate the downhole surface and means to retract each applicator radially inwardly when not required, such as when the tool is not in use and is being transported up or down the well. An applicator may be shaped so that spacing between the downhole surface and a confronting surface of the applicator narrows to a minimum as the applicator skims over the downhole surface.

It is possible that, as curable composition is being applied, an opaque portion of an applicator contacts the composition and defines one boundary of a gap between the applicator and the downhole surface while the light transmitting barrier is positioned to follow the opaque portion across the downhole surface. A surface of the barrier may be aligned with a surface of the opaque portion and in some embodiments a surface of the barrier may be a smooth (and possibly an uninterrupted) continuation of a surface of the opaque portion. The light-transmitting barrier and the opaque portion of the applicator may both have a fluorocarbon at a surface, facing the surrounding downhole surface in order to mitigate adhesion of the curable composition. This surface may be provided by a single piece of fluorocarbon polymer. It may be a fluorocarbon, which may be a fluorocarbon polymer, as a coating on another material. In some other embodiments there is a brief discontinuity between a portion of the applicator which spreads the curable composition as a layer and a following portion of the applicator which comprises the light transmitting barrier.

Another possibility is that the applicator comprises a body part which is formed of fluorocarbon polymer and includes a region which is sufficiently thin to allow light transmission through it and so provides the barrier.

A fluorocarbon polymer used in an applicator as above may be a polymer or copolymer of one or more monomers which are fluorocarbons. One possibility is polytetrafluoroethylene (PTFE). Another is fluorinated ethylene propylene (FEP) which is a copolymer of hexafluoropropylene and tetrafluoroethylene. A further possibility is perfluoroalkoxy polymer resin (PFA) which is a copolymer of tetrafluoroethylene and trifluoromethoxy trifluoroethylene.

Possibilities other than fluorocarbon polymers include clear silicone rubbers, ultrahigh molecular weight polyethylene and other polyolefins.

A further possibility is that the light-transmitting barrier is such that it remains stationary or slow moving relative to the coating layer on the downhole surface while light is directed through it. This can be achieved if the material of the barrier moves relative to the applicator. The barrier may be provided by light transmitting material which is moving relative to other structure of the applicator and so moves more slowly than other structure of the applicator relative to the downhole surface and may be stationary relative to this surface. The light transmitting material may be a laminar web and/or may be formed into a continuous band.

So in a further aspect of this disclosure, there is provided a method of applying a photocurable coating to a downhole surface surrounding the axis of a wellbore containing a fluid, the method comprising

placing in the wellbore a downhole tool comprising an applicator which is an assembly comprising support means for positioning an area of light transmitting material facing the downhole surface;

moving the assembly over the downhole surface while supplying a photocurable composition to enter between the said area of light transmitting material and the downhole surface, the said area of light transmitting material being in contact with curable composition between the portion of the web and the downhole surface and moving more slowly over the downhole surface than other parts of the applicator assembly (and may be stationary relative to the downhole surface); and

directing light of wavelength in a range from 100 nm to 1500 nm through the said area of light transmitting material onto the curable composition so as to initiate curing of the composition between the said area of light transmitting material and the downhole surface. The area of light transmitting material may be a portion of a laminar web. The light transmitting material may have a surface to give low adhesion to the curable composition. This surface may be fluorocarbon or silicone.

The support means may comprise a pair of rotary elements spaced one from another and the laminar web may be a belt running in a continuous loop over these rotary elements so that a portion of the belt moves over the downhole surface more slowly than the support means and may be stationary relative to the downhole surface. Separation of the belt from the composition after exposure to the light which initiates curing will then be a peeling action. The assembly may comprise a light output positioned between the rotary elements and within the loop of the belt so that it can direct light through the said portion of the belt.

Another possibility is that a band of light transmitting material is at the exterior of a roller which contacts the downhole surface. A light source may be positioned within the roller so as to direct light onto the curable composition through the roller.

In a further aspect, there is disclosed a wellbore tool for applying a photocurable coating to a downhole surface surrounding the axis of a wellbore wherein the tool comprises

an applicator which is an assembly which comprises a laminar web of light-transmitting material and support means for positioning a portion of the web facing the downhole surface;

means to deliver a photocurable liquid composition to enter between that said portion of the web and the downhole surface

means for moving the assembly over the downhole surface with the said portion of the web moving more slowly over the downhole surface than other parts of the applicator assembly (and possibly remaining stationary relative to the downhole surface), and

at least one light output configured to direct light through the said portion of the light-transmitting belt towards the downhole surface.

Curing of the composition may be a polymerisation reaction, possibly involving crosslinking and/or chain elongation of a pre-polymer. The photocurable composition and the light used to initiate curing may be as disclosed in U.S. Pat. No. 7,931,091 or [0026] US2010/0247794. In some embodiments the light lies in a wavelength range with a lower limit of 200 nm or 250 nm. Independently of the lower limit the wavelength range may extend up to 1200, 900 or 800 nm. It will be appreciated that the term “light” is being used here to include ultra-violet and infra-red electromagnetic radiation as well as the visible range which is generally taken to be from about 380 nm to about 750 nm. “Actinic radiation” is another term for light in a range which includes and extends beyond the visible range.

The photocurable composition used with applicators as disclosed herein may be formulated to have a viscosity which is greater than the viscosity of the wellbore fluid, perhaps at least 10 times the viscosity of the wellbore fluid, at the place of application to the downhole surface. The composition may possibly have a viscosity at ambient temperature of at least 1 Pa.sec.

This photocurable composition may contain one or more materials capable of undergoing polymerisation, together with a photoinitiator such that exposure of the composition to light from the light output causes the photo initiator to liberate reactive species which react with the polymerisable material and cause polymerisation to begin. Depending on the nature of the polymerisable material which is employed, the mechanical properties of the layer of cured composition may range from hard and rigid to flexible.

In some embodiments of this invention, external energy supplied to the downhole location is used to initiate the reaction, but not to sustain it. The chemistry of the polymerisation reaction may be chosen such that once it has begun, the polymerization reaction propagates at the temperature of the downhole location where it takes place. This may be a higher temperature than the ambient temperature prevailing on the surface. The polymerisation reaction may be exothermic and may accelerate as it proceeds (so-called auto-acceleration) until the rate of reaction is restrained by consumption of polymerisable material and decreasing mobility of the polymer molecules within the composition as their size grows. The amount of energy supplied as light may be less than would be required for a polymerisation brought about by electrical heating.

By using light energy rather than temperature to initiate polymerisation, the beginning of polymerisation will not be coupled to wellbore temperature, even though wellbore temperature will have an effect on the rate of polymerisation after it has begun.

### BRIEF DESCRIPTION OF THE DRAWINGS

FIG. 1 is a schematic view of the lowest portion of a wellbore and a drill string bottom hole assembly which includes an applicator for photocurable coating to line the wellbore;

FIG. 2 is a schematic view of a portion of a cased wellbore and a wireline tool for applying a polymer lining to the casing tubing;

FIGS. 3, 4 and 5 are schematic cross-sectional views of embodiments of applicator for applying a photocurable composition;

FIG. 6 is a detail of a part of FIG. 5 illustrating a space for a liquid film between a layer of curable composition and a light transmitting sheet extending over it;

FIGS. 7 to 11 are schematic cross-sectional views of further embodiments of applicator for applying a photocurable composition;

FIG. 12 is a schematic top view of another embodiment of applicator for applying a photocurable composition;

FIG. 13 is an exploded view of the applicator of FIG. 12;

FIG. 14 shows apparatus used in the laboratory experiment which is Example 1.

FIGS. 15 and 16 are histograms of particle size distribution obtained in Example 2; and

FIG. 17 shows apparatus used in the laboratory experiment which is Example 3.

### DETAILED DESCRIPTION

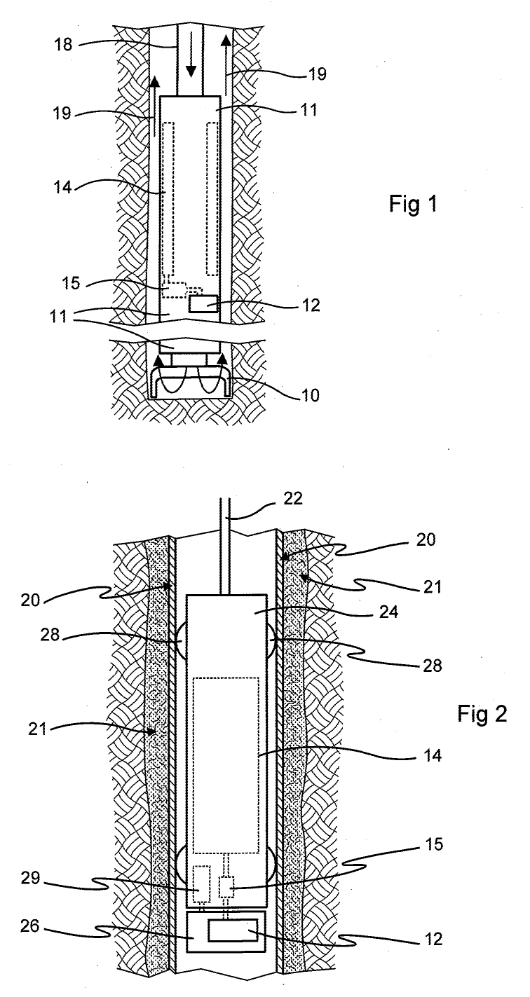

FIG. 1 shows part of a wellbore in which there is the lower end portion of a drill string terminating in a drill bit 10. The drill string is positioned in the wellbore, shown here as vertical but which could be deviated to extend at an inclined angle or horizontally. It will be appreciated that at this stage when the drill string is present in the wellbore, the lowest portion of the borehole, shown here, is an open hole without casing. Connected above the drill bit 10 is a bottom hole assembly 11 which may include measuring equipment. In this embodiment it is also a tool with an applicator 12 for applying a photo curable liquid composition to the wall of the wellbore. The photocurable composition is supplied, when required, to the applicator 12 from an annular tank 14 by means of a pump 15.

As is conventional, drilling mud is supplied down drill pipe 18. It passes through apertures (not shown) in drill bit 10 and returns carrying cuttings upwardly along the annulus around the bottom hole assembly 11 and drill pipe 18, as indicated by arrows 19. Thus, the applicator operates whilst submerged in drilling mud which is returning to the surface. The applicator 12 may be used to apply photocurable coating composition to the wellbore wall as drilling proceeds, or alternatively drilling may be stopped and the drill string drawn upwardly by a short distance before utilising the applicator 12 to apply coating to the wellbore wall. With both of these possibilities the coating is applied without tripping the drill string out of the borehole.

FIG. 2 shows a portion of a wellbore which has been cased with steel tubing 20 with cement 21 filling the space between the tubing 20 and the surrounding geological formation. In order to apply a polymer lining to the interior surface of the tubing 20, for example to repair a portion of the tubing, a downhole tool having upper and lower parts 24, 26 is lowered into the wellbore by means of wireline 22. This wireline provides (as is normal for wireline operations) an electrical power supply from the surface to the tool and data and control communication between the tool and the surface.

The tool's upper body part 24 is centred within the tubing 20 and constrained against rotation by centering devices 28 pressed outwardly against the tubing 20. Below this upper part 24 is a lower body part 26 which can rotate around the longitudinal axis of the tool, driven by motor 29. The lower body part 26 carries an applicator 12 for applying a photo curable liquid composition to the inside face of tubing 20. The photocurable composition is supplied, when required, to the applicator 12 from a tank 14 in the upper part 24 of the tool by means of a pump 15.

FIGS. 1 and 2 both show one applicator 12. However, the bottom hole assembly in FIG. 1 and the lower part 26 of the tool in FIG. 2 could each have two similar applicators at diametrically opposite sides, or could have three or more applicators distributed around the tool axis.

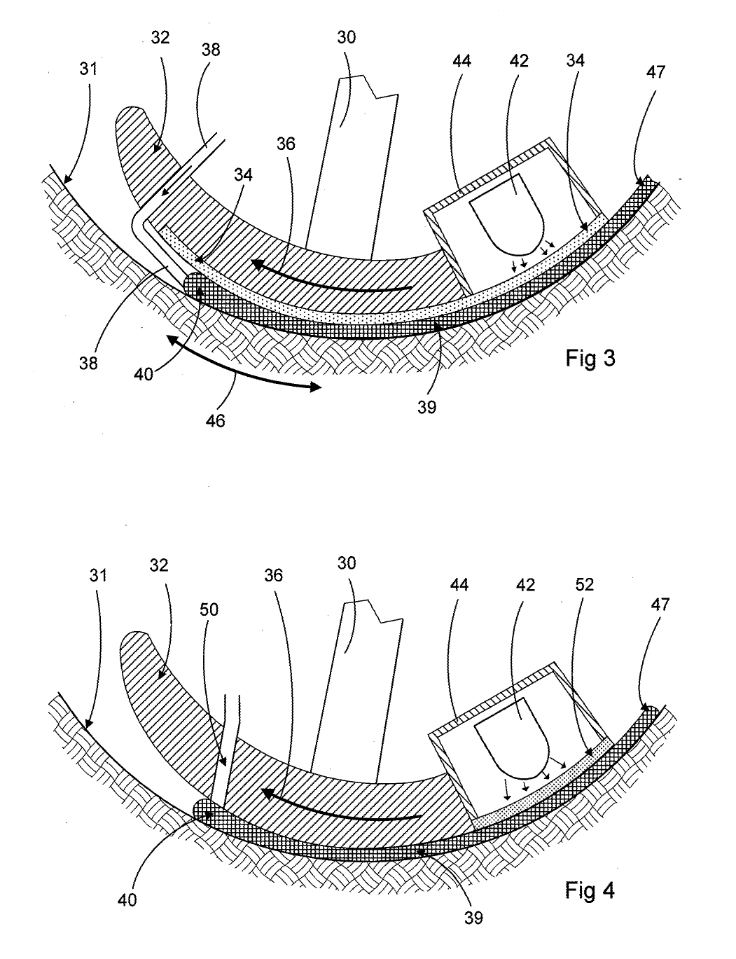

FIG. 3 onwards show possible forms of applicator 12 which may be used in the bottom hole assembly of FIG. 1 or in the wireline tool of FIG. 2. In each case the applicator is seen looking in the direction of the wellbore axis, that is looking downwardly in FIGS. 1 and 2. For convenience, these forms of applicator will be described as carried on the bottom hole assembly of FIG. 1 and used to coat a wellbore wall 31. However, the manner of operation when the applicator is carried on the lower part 26 of the wireline tool of FIG. 2 is the same as when it is carried on the bottom hole assembly of FIG. 1 except that the inside of tubing 20 takes the place of the wall 31 of the wellbore as the downhole fixed surface to which curable composition is applied. It should also be appreciated that the wellbore tool of FIG. 2 could be used to line an open hole wellbore.

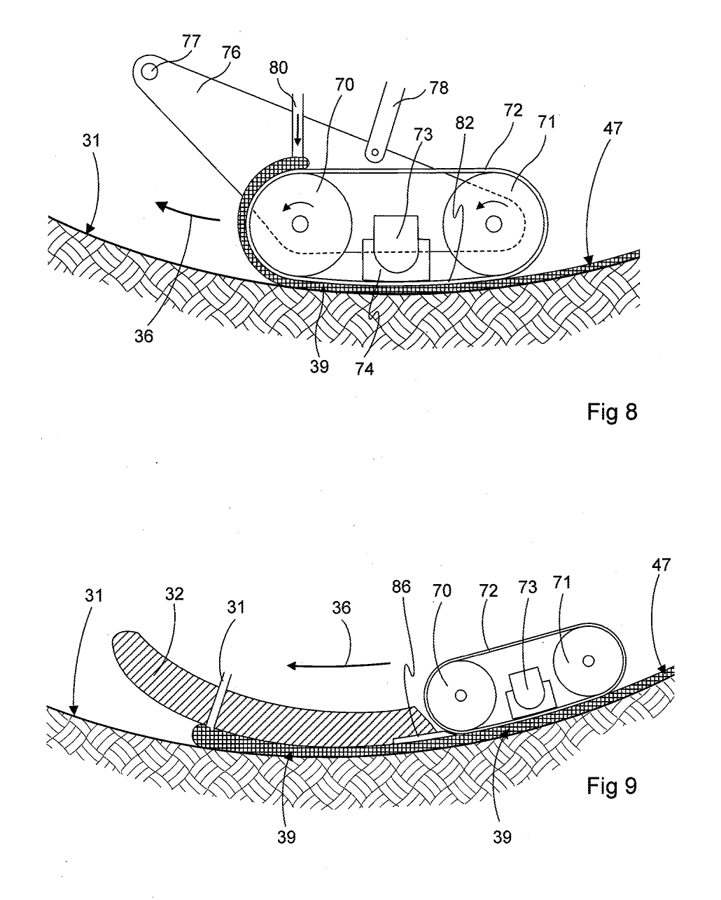

Referring to FIG. 3, the applicator is carried on a support 30 which is used to move applicator outwardly from the bottom hole assembly of FIG. 1 for operation and also to retract it when not in use. In this embodiment, the support 30 carries the applicator bodily outwardly or inwardly. A possible alternative is for the applicator to be pivotally attached to the bottom hole assembly or wireline tool and swung outwardly around the pivot as illustrated by the applicator shown in FIG. 8 below. The support 30 includes a spring or other compliant element so that when the applicator has been moved out to the position shown in FIG. 3, it is being pushed gently towards the wall 31 of the wellbore.

The applicator has a main body 32 with a sheet 34 of polytetrafluoroethylene (PTFE) at its outer surface facing the wellbore. This sheet is translucent, allowing light to pass through it, with some diffusion. The applicator is traversed across the surface of the wellbore, in the direction indicated by arrow 36 as the drill string rotates. Consequently the outer surface of sheet 34 is carried across the wellbore wall 31 which it faces. Liquid photocurable composition 39 is supplied along pipe 38 and discharged at 40 between the sheet 34 and the wellbore wall 31.

The application has a light source 42, which in this embodiment is one or more light emitting diodes emitting light at one or more wavelengths in a range from 200 to 600 nm, which is ultra-violet through to green light. These are contained within a housing 44 attached to the applicator body 32 and sealed to the sheet 34. The light source 42 is positioned to direct light onto and through the sheet 34.

The applicator is shaped so that within the arc 46 the spacing between the sheet 34 and the wall 31 of the wellbore progressively narrows as the applicator advances over the wellbore wall 31, forcing the liquid photo curable composition 39 to spread out into a layer between the wellbore wall 31 and the sheet 34. The cross-section of the pipe 38 is fairly small so that the composition 39 is discharged at an approximately a single point. This helps the composition to fill and bridge the gap between the sheet 34 and the wellbore wall 31 as it spreads into a layer and so displace wellbore fluid from this gap. The curable layer which is formed from composition 39 is in contact with both the sheet 34 and the wall 31 and so bridges the spacing between them. Next, the light source 42 travels over the composition 39 which has been spread by the sheet 34 and photo curing of this composition is initiated by the light from source 42 passing through the translucent sheet 34 to reach the composition 39. The photocuring causes the layer of polymer composition 39 to become a solid layer adhering to the wellbore wall 31 as indicated at 47.

The sheet 34 provides a light transmitting barrier between the light source 42 and the photo curable composition 39, protecting the light source from contact with the composition and hence preventing the composition becoming attached to the light source by curing while in contact with it. We have found that a sheet 34 of a fluorine containing polymer such as PTFE avoids wetting by the photocurable composition, thus minimising attachment of the composition 39 to the sheet 34 as the composition cures.

Because a layer of the composition 39 fills the gap created by the composition entering between the sheet 34 and the wellbore wall 31, drilling mud is largely prevented from entering the path of light from the light source 42 to the curable layer which has been spread on the wellbore wall 31 and consequently light attenuation by the opaque drilling mud is avoided.

FIGS. 4 to 7 show applicators which have a number of features similar to those in FIG. 3 and these are indicated by the same reference numerals. However, in FIG. 4 the steel main body 32 of the applicator is in contact with the curable composition 39 which is delivered along a pipe 50 passing through the applicator body 32. The surface of the body 32 which faces the wellbore wall 31 is continued by a light transmitting PTFE sheet 52 which is shorter than the sheet 34 in FIG. 3. The housing 44 is sealed to the sheet 52.

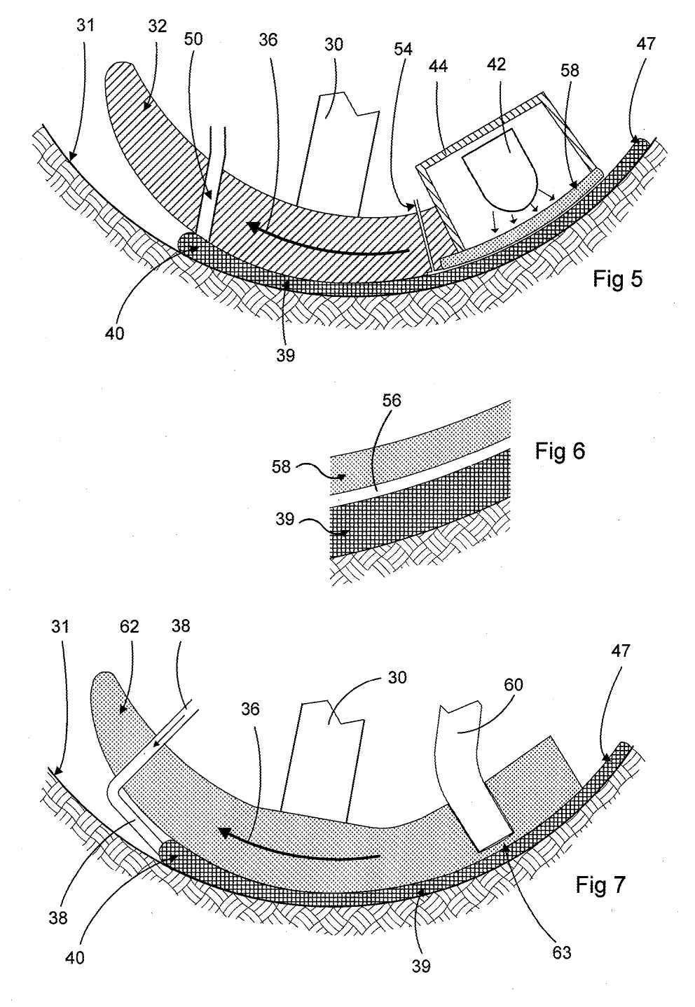

FIG. 5 shows a variation on the applicator of FIG. 4. The housing 44 containing the light emitting diodes is sealed to a light transmitting sheet 58. The photocurable liquid composition 39 is delivered through a pipe 50 and the narrowing distance between the applicator body 32 and the wellbore wall 31 causes the photocurable composition to spread out and form a layer between them, just as in FIG. 4. However, a transparent liquid is supplied in small quantity along pipe 54 so as to form a thin film of this liquid over the spread layer of curable composition and filling a narrow space 56 between the curable composition 39 and the light-transmitting sheet 58 as shown by the enlarged view in FIG. 6. In consequence, unwanted curing of the composition 39 onto the surface of the sheet 58 is here prevented by the presence of the film of clear liquid between the composition 39 and the sheet 58 rather than by requiring the sheet 58 to have a non-stick property. This allows a wider range of light-transmitting materials to be used for the sheet 58 than for the sheets 34, 52 of FIGS. 3 and 4.

FIG. 7 shows an embodiment with two main differences from the embodiment of FIG. 3. It should be appreciated that these features could be used separately if desired. Firstly, instead of light emitting diodes, the light source which directs light onto the composition is the outlet end of a light guide 60 carrying light from a lamp which may for example be a mercury vapour discharge lamp elsewhere in the bottom hole assembly. Such a lamp emits at several wavelengths between 200 and 600 nm. The light guide 60 is a bundle of optical fibres within a surrounding sheath. Each optical fibre has an elongate core filament of glass or of organic polymer surrounded by one or more layers of cladding, with the core having a higher refractive index than the cladding, so that light introduced at one end of the fibre will be internally reflected for transmission longitudinally within the core to the other end of the fibre.

A light guide may also be formed from a liquid core within an enclosing tube where the refractive index of the liquid core exceeds that of the tube. Use of a liquid core or use of a bundle of separate optical fibres within a sheath allows such light guides to be flexible. Light guides are available from various manufacturers including Universal Fibre Optics Ltd, Coldstream, Scotland.

Secondly the embodiment in FIG. 7 differs from FIG. 3 in that the applicator has a main body 62 which is made of PTFE. The end portion of the light guide 60 is sealed into a cavity in the body 62 so that the outlet end of the light guide 60 directs light onto and through a portion 63 of the body 62 which is sufficiently thin to have good light transmission. This portion 63 of the body 62 provides a light transmitting barrier between the photocurable composition 39 and the light guide 60.

FIG. 8 shows an applicator which has a pair of freely rotatable rollers 70, 71 with a belt 72 running on these rollers 70, 71. This belt 72 is made of flexible light-transmitting polyurethane with a coating of PTFE lubricant particles on its surface. Other possible materials for this belt include silicone rubber, PTFE and FEP. A light source 73 is positioned between the rollers 70. This light source comprises light emitting diodes, similar to the diode 42 in FIG. 1, partially embedded in a block 74 of light transmitting silicone rubber which is in sliding contact with the inside face of the belt 72.

This assembly of parts 70-74 is supported by a pair of arms 76 (the lower one of these arms 76 is shown in FIG. 8) pivoted at 77 on the bottom hole assembly of FIG. 1. The arms 76 and the assembly of parts 70-74 carried on them can be swung outwardly towards the wellbore wall 31 when required by a rod 78 extensible from the bottom hole assembly. A similar arrangement of arms 76 and rod 78 could likewise be used if this applicator was carried on the lower part 26 of the wellbore tool of FIG. 2.

When required for use the applicator is positioned as shown in FIG. 8. The extensible rod 78 incorporates a spring or other compliant element, so that the applicator is being pushed onto the wellbore wall. As the applicator is advanced across the wellbore wall 31 in the direction indicated by arrow 36, a portion 82 of the belt which extends between the rollers 70, 71 and is adjacent to the wellbore wall 31 remains stationary relative to the wall 31. The rollers 70, 71 turn as indicated by arrows. This manner of motion is analogous to that of a tracked vehicle in which the lowest part of the track is stationary on the ground.

It is possible that the portion 82 of the belt is not completely stationary relative to the wellbore wall 31 but instead slides slowly over the layer of the photocurable composition 39. Whether the portion 82 of the belt is stationary or is moving slowly relative to the wellbore wall 31, the belt is travelling over the rollers 70, 71 and in consequence the portion 82 of the belt is moving over the wellbore wall more slowly than the light source 73 and other structure of the applicator.

Photo curable composition 39 is delivered along a pipe 80 which deposits it on the belt and travel of the belt 72 on the rollers 70, 71 carries the composition in between the portion 82 of the belt and the wellbore wall 31. This spreads the composition 39 as a layer on the wellbore wall 31 and the spread layer of this composition bridges the gap created between the belt portion 82 and the wall 31.

Light from source 73 is directed through the belt onto the layer of curable composition 39 and initiates curing of the composition onto the wellbore wall. The cured layer on the wellbore wall is indicated at 47.

In this embodiment the portion 82 of the light transmitting belt 72 provides a barrier between the light source 73 and curable composition 39 but this portion 82 of the belt does not slide over the composition 39 as it is curing. When it separates from the layer of composition at the trailing roller 71, the separation is a peeling action rather than a sliding motion. The block 74 of silicone rubber in contact with the inside face of the belt 72 inhibits entry of drilling mud into the light path from the light source to the curable composition 39. However, if the wellbore fluid contains suspended solids, as is the case with drilling mud, we have found that it is desirable to structure the surface of the block 74 where it contacts the belt 72 so that the block has shallow grooves between ribs which contact the belt. These grooves are dimensioned to provide an exit path for any solid particles which do enter between the block 74 and the belt 72

FIG. 9 shows an arrangement in which the applicator has both a body part 32 as shown in FIGS. 3 to 5 and an assembly of parts 70-74 as in FIG. 8. The body part 32 and the assembly 70-74 are carried by a support (not shown) which is able to carry them bodily outwardly and inwardly analogously to the support 30 in FIG. 3. The curable composition is delivered through the body part 32 which causes the composition 39 to spread into a layer bridging the gap between the wellbore wall 31 and the body part 32 as in FIG. 4. Curing of the composition which has been applied is then carried out with the assembly of parts 70-74 as in FIG. 8. The body part 32 has a short piece 86 of PTFE which wipes the exterior of the belt as it comes off the roller 70 onto the layer of curable composition 39, thus largely excluding drilling mud from entering between the belt 72 and the curable composition 39.

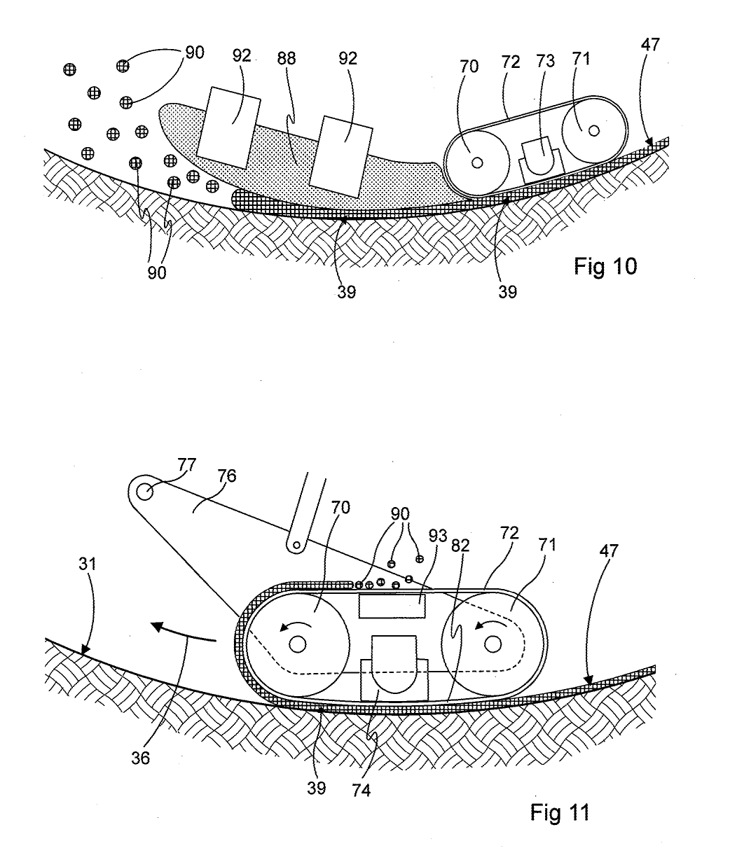

FIG. 10 shows a further possibility. It is constructionally similar to FIG. 9 but the applicator body part 88 is made of PTFE or another non-magnetic material. When it is required to apply curable composition to the wellbore wall 31 the applicator is extended to the position shown and a quantity of the photocurable composition, mixed with small particles of iron, is introduced at the surface into the drilling mud which flows down the drill string and, as was shown in FIG. 1, passes out through the drill bit into the annulus around the bottom hole assembly. Droplets 90 of the photocurable composition suspended in the drilling mud are attracted by electromagnets 92 fitted to the applicator body 88, and so drawn into the narrowing gap between the applicator body 88 and the wellbore wall 31, so that a layer of curable composition on the wellbore wall 31 is formed from these droplets of composition harvested from the drilling mud by means of the electromagnets 92. The layer of curable composition is then cured by the assembly of parts 70-74 following immediately behind the applicator body 88. It is also possible that permanent magnets might be employed here in place of the electromagnets shown in the drawing.

FIG. 11 shows an applicator which is constructionally similar to the applicator of FIG. 8. However, a magnet 93 (which may be a permanent magnet or an electromagnet) is provided within the belt 72. Droplets 90 of the photocurable composition suspended in the drilling mud are drawn onto the belt 72 by the magnet 93 and form a layer of composition on the belt as the belt travels on the rollers 70, 71. Travel of the belt 72 carries the composition 39 on the belt around the roller 70 to enter in between the portion 82 of the belt and the wellbore wall 31 where is cured by light as described above with reference to FIG. 8.

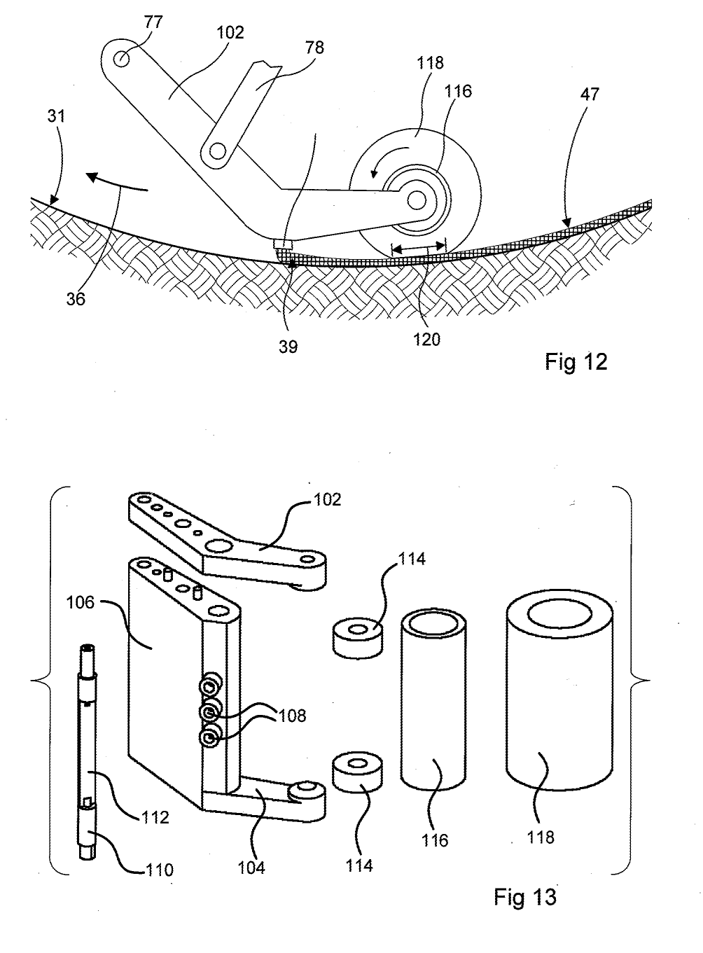

FIGS. 12 and 13 show a further form of applicator. FIG. 12 is laid out similarly to FIG. 8 in a top view onto the applicator. FIG. 13 is an exploded view of the applicator assembly.

This applicator has upper and lower arms 102, 104 connected by a block 106 which is moulded integrally with the lower arm 104. The arms 102, 104 are pivoted at 77 on the bottom hole assembly of FIG. 1. The block 106 incorporates outlet nozzles 108 for dispensing curable composition which may be delivered to the block 106 via a hose or pipe (not shown). The arms 102, 104 support the upper and lower ends of a generally cylindrical axle 110 which incorporates a light source 112 comprising light emitting diodes within a transparent material. Bearings 114 are positioned at the top and bottom of the axle 110 and a roller is supported by these bearings so as to be freely rotatable. The roller comprises a central tube 116 of rigid transparent material which supports a surrounding sleeve 118 of deformable light transmitting material. The cavity between the rotating rigid transparent sleeve 116 and the non-rotating light 112 may be filled with a transparent fluid (for example glycerol) to aid pressure stabilisation with wellbore fluids. The sleeve 118 is light transmitting material formed as a continuous band.

Functionally, the deformable material 118 acts analogously to the belt in FIG. 8. When required for use, the applicator is pushed onto the wellbore wall by a rod 78. The deformable material 118 is then pressed against the wellbore wall. As the applicator advances, the roller, which of course includes sleeve 118, turns in the direction indicated by an arrow. A section 120 of the light transmitting sleeve 118 with an extent denoted by the double headed arrow 122 is deformed as it is pressed against the wellbore wall and remains stationary relative to the wellbore wall.

Photo curable composition 39 is delivered onto the wellbore wall from the nozzles 108 and pressure from the sleeve 118 of the roller spreads the composition 39 as a layer on the wellbore wall 31. The spread layer of this composition bridges the gap created between the section 120 of the sleeve 118 and the wellbore wall 31.

Light from source 112 is directed through the material 118 onto the layer of curable composition 39 and initiates curing of the composition onto the wellbore wall. The cured layer on the wellbore wall is indicated at 47.

In this embodiment the section 120 of the light transmitting belt 72 provides a barrier between the light source 112 and curable composition 39 but this section 120 of the belt does not slide over the composition 39 as it is curing. When it separates from the layer of composition, the separation is a peeling action rather than a sliding motion.

Use of a tool as in FIG. 1 or FIG. 2 provided with one or more applicators as in FIGS. 3 to 13 when required to deliver a composition onto a downhole surface (which could be the wellbore wall or the interior of tubing) may comprise rotating the bottom hole assembly 11 of FIG. 1 or the lower body part 26 of FIG. 2 in order to skim the applicator over the downhole surface while also moving the tool linearly in the wellbore so that photo cured composition is applied in a helical pattern.

When the tool is the bottom hole assembly of FIG. 1, application of the photocurable composition may take place while drilling. It could also be done with drilling stopped and the drill string moved slowly up the wellbore as photocurable composition is applied and cured. This would of course be an interruption to drilling, but the interruption would be relatively short because there would be no need to trip the drill string out of the wellbore. An analogous possibility would be to draw the drill string back from the end of the wellbore by short distance and then apply a photocurable composition while advancing the drill string forwardly towards the end of the wellbore.

The wireline tool of FIG. 2 can be used to apply photo curable composition whilst being lowered or raised within the wellbore.

Both with the bottom hole assembly of FIG. 1 and the tool of FIG. 2 the rates of linear and rotary motion may be chosen so that there is no separation between successive turns of the helix which is applied and the composition forms a complete covering of the downhole surface over the length of wellbore to which composition is applied. The rates of motion may be chosen such that successive turns of the helix overlap.

For use with any of the applicators described above, the photocurable composition may comprise one or more compounds which are able to participate in a polymerization reaction and thereby extend a growing polymer chain. Such compounds may provide at least 50% probably at least 80% or 85% of the liquid components of the polymerizable composition. The composition may also contain a minor proportion of one or more compounds with a greater number of groups able to participate in the polymerization reaction and so create branching of polymer chains or cross-linking between polymer chains. Such a crosslinking agent and may be present as up to 15%, possibly 1 to 10% by weight of the liquid components of the curable composition.

Polymerizable compounds contain at least one reactive group to enable polymerisation to occur. In some embodiments envisaged for use as disclosed here, the polymerizable compounds may be linear molecules with a reactive group at each end, such as esters of an olefinically unsaturated acid and a dihydroxy compound (although such esters may be manufactured using other starting materials such as an acid chloride, of course) The acid moiety may be an olefinically unsaturated acid containing 2 to 5 carbon atoms notably acrylic or methacrylic acid.

Some examples of such monomer compounds are: bisphenol A ethoxylate diacrylates, having the general formula

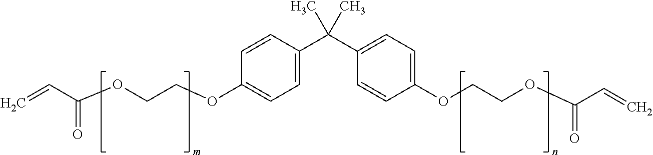

bisphenol A ethoxylate dimethacrylates, having the general formula

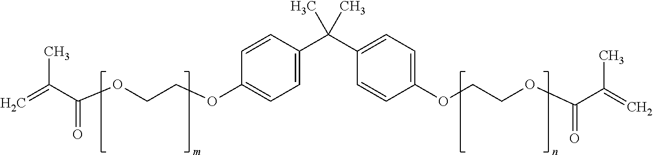

and poly(ethylene glycol) diacrylates having general formula:

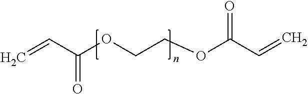

In the above three general formulae, m and n are average values and may vary. Possibly m and n will each lie in a range up to 15, such as 1 or 1.5 up to 6. We have found that monomers containing ethylene oxide residues improve flexibility of the cured polymer but reduce its strength.

A compound able to act as a crosslinker may have more than two olefinically unsaturated groups, to create branched or cross-linked polymer chains. Such compounds may be acrylate or methacrylate esters of poly hydroxy compounds.

Some examples are as follows:

| | | MW |
|---|---|---|
| Name | Formula | (g/mol) |
| trimethylolpropane triacrylate | 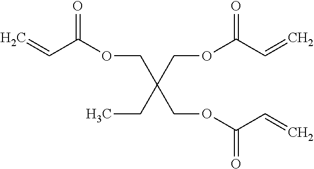 [SMILES: C=CC(=O)OCC(CC)(COC(=O)C=C)COC(=O)C=C] | 296 |
| trimethylolpropane ethoxylate triacrylate | 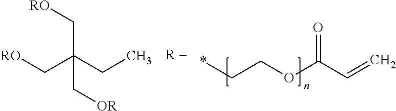 | |
| The average value of n in the above formula may be chosen so that the mean | | |
| molecular weight is about 430, about 600 or about 900 | | |
| pentaerythritol tetraacrylate | 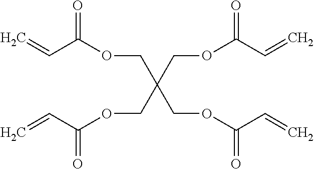 [SMILES: C=CC(=O)OCC(COC(=O)C=C)(COC(=O)C=C)COC(=O)C=C] | 352 |
| di(trimethylolpropane) tetraacrylate | 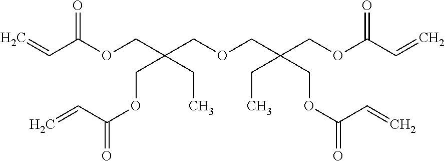 [SMILES: C=CC(=O)OCC(CC)(COCC(CC)(COC(=O)C=C)COC(=O)C=C)COC(=O)C=C] | 466 |

Monomer compounds with two olefinically unsaturated groups may also be vinyl ethers such as 1,6-hexane diol divinyl ether, poly(ethylene glycol) divinyl ether, bis-(4-vinyl oxy butyl)hexamethylenediurethane, and vinyl ether terminated esters such as bis-(4-vinyl oxy butyl) adipate and bis-(4-vinyl oxy butyl) isophthalate.

Another possibility is that the groups able to participate in the polymerization reaction are epoxide groups. A suitable category of monomer compounds containing epoxide groups are glycidyl ethers of dihydroxy compounds, some specific possibilities being 1,6-hexanediol diglycidyl ether, bisphenol A diglycidyl ether and poly(ethylene glycol) diglycidyl ether.

The photocurable composition may comprise a mixture of monomers. Notably a mixture of monomers may be used in order to obtain a desired combination of mechanical properties of the polymer lining on the tubing. The monomers will generally provide at least 50 wt % of the composition and preferably from 70 to 99.5 wt % of it.

In addition to the polymerizable compounds and photoinitiator the photocurable liquid composition may include various other materials. One possibility is a leveling agent or a wetting agent to aid adhesion to the downhole surface. Such an agent may be a surfactant to displace any film of wellbore fluid on the surface of the tubing which is about to have the photocurable composition applied to it. Such a surfactant may be monomeric or polymeric and may include a reactive moiety such as an acrylate group to enable it to copolymerize with the main monomers of the composition. More specifically it may be a silicone polymer with pendant acrylate groups. Examples are available as TEGO RAD from Evonic Tego Chemie, Essen, Germany and EFKA 3883 from Ciba Inc. The amount (if any) of such additives are likely to be no more than 5 wt % of the composition.

The photocurable composition may include an additive to increase its viscosity. Examples of rheology modifiers which may be added to the composition to enhance viscosity are fumed silica, clays and high molecular weight organic polymers. The amount (if any) of a material added solely to enhance viscosity is likely to be no more than 5 wt % of the composition.

The photocurable composition may include one or more suspended solids serving to reinforce it after polymerisation such as bentonite clay particles, or short fibres such as chopped glass fibres. These materials may have an additional effect of enhancing viscosity. The amount of suspended solids in a photocurable composition may possibly range from 0 to 60 volume % of the composition and in some embodiments may lie in a range from 0 to 20 volume % of such solids.

A photoinitiator in the curable composition is a compound that it is capable of generating a reactive species effective to initiate polymerisation upon absorption of light. The initiating species which is generated may be a cation or a free radical. A photo initiator may therefore be referred to as a cation photo initiator or a radical photo initiator respectively.

A radical photo initiator may be a type I (cleavage type) or a type II (H-abstraction and electron donor) initiator. A type I initiator undergoes a unimolecular bond cleavage (α-cleavage) upon irradiation to yield the free radical. A type II initiator undergoes a bimolecular reaction where the triplet excited state of the photoinitiator interacts with a second molecule, which may be another initiator molecule, to generate a free radical. Typically, the second molecule is a hydrogen donor. Where the second molecule is not another initiator molecule, it may be referred to as coinitiator. The coinitiator may be an amine, alcohol or ether. Preferably, the coinitiator is an amine, most preferably a tertiary amine. Where the second molecule is another initiator molecule, the initiator may contain amine, alcohol or ether functionality.

Type I cleavable photo-initators include benzoin ethers, dialkoxy acetophenones, phosphine oxide derivatives, amino ketones, e.g. 2-dimethyl, 2-hydroxyacetophenone, and bis(2,4,6-trimethyl benzoyl) phenyl phosphine oxide.

Type II initiator systems (photoinitiator and synergist) include aromatic ketones e.g. camphorquinone, thioxanthone, anthraquinone, 1-phenyl 1,2-propanedione, combined with H donors such as alcohols, or electron donors such as amines.

A cation photo-initiator is preferably a photoacid generator, typically a diazonium or onium salt, e.g. diaryliodonium or triarylsulphonium hexafluorophosphate.

Photo initiator will generally be a small percentage of the photocurable composition. The percentage of photo initiator in the composition is likely to be a least 0.5% by weight and may extend up to 3% or even 10% by weight of the liquid components of the composition.

### Example 1

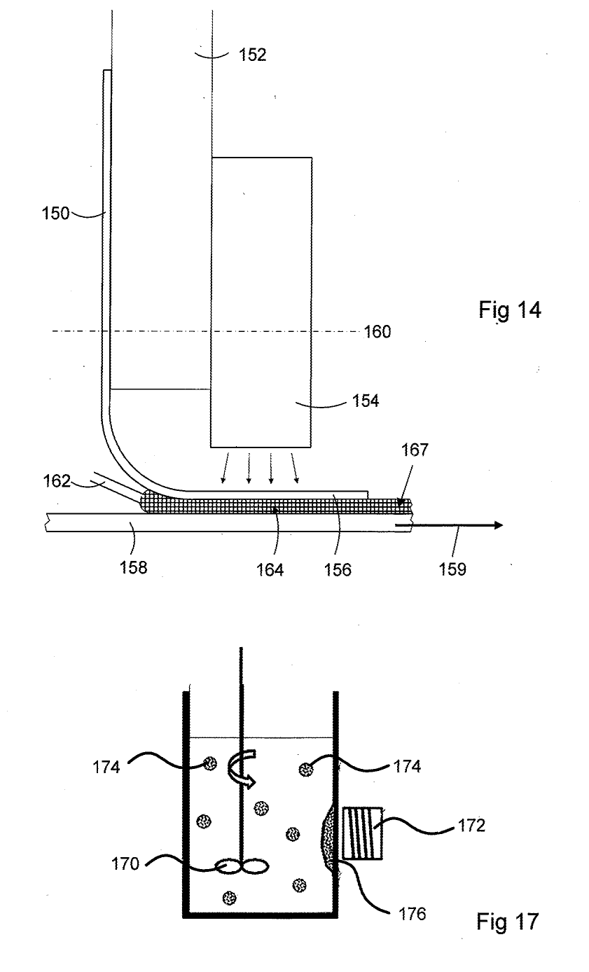

A laboratory experiment was carried out to demonstrate curing of a composition with light directed through a light transmitting sheet. As shown in FIG. 14, a lamp 154 emitting white visible light and a sheet 150 of PTFE were attached to a support 152 extending from above into a cylindrical dish. A portion 156 of the sheet 150 curved round below the lamp to rest on the base 158 of the dish. Light from the lamp 154 was directed, as shown by arrows, through this portion 156 of the sheet onto the base 158 of the beaker. The dish was partially filled with oil to the level shown by line 160, thus immersing the portion 156 of sheet 150 and the light outlet of the lamp 154.

A photocurable liquid composition was prepared with the following formulation.

| Function | Material | Wt % |
|---|---|---|
| polymerisable diacrylate | Bisphenol A ethoxylate diacrylate | 68.23 |
| polymerisable diacrylate | PEG Diacrylate | 22.75 |
| crosslinking agent | Pentaerythritol triacrylate (PETA) | 2.27 |
| photoinitiator | Irgacure 784 | 0.19 |
| photoenhancer | Methylene Blue | 0.04 |
| clay particles | Bentone SD-2 | 1.87 |
| polymer chain terminator | Isobornyl acrylate (IBA) | 4.66 |

This composition was observed to be immiscible with water and also to be immiscible with hydrocarbon oil.

This composition was delivered through a pipe 162 onto the base 158 of the dish as the dish was rotated on a turntable. Motion of the base of the dish relative to the remainder of the apparatus is indicated by arrow 159 and this relative movement carried the photocurable composition beneath the portion 156 of the PTFE sheet so that it spread as a layer 164 bridging a gap between the portion 156 of the sheet and the base 158 of the dish and was then carried beneath the lamp. The layer 164 of photocurable composition was cured to form a flat strip 167 of solid material on the base 158 of the dish.

### Example 2

A laboratory experiment was carried out to demonstrate preparation of a dispersion of a magnetic photocurable composition in an immiscible liquid. A magnetic photocurable composition was prepared from the following materials

| Function | Material | Wt % |
|---|---|---|
| polymerisable diacrylate | Bisphenol A ethoxylate diacrylate | 35.84 |
| polymerisable diacrylate | PEG Diacrylate | 11.95 |
| crosslinking agent | Pentaerythritol triacrylate (PETA) | 1.19 |
| photoinitiator | Irgacure 784 | 0.10 |
| photoenhancer | Methylene Blue | 0.02 |
| clay particles | Bentone SD-2 | 0.98 |
| polymer chain terminator | Isobornyl acrylate (IBA) | 2.45 |
| iron powder | ATOMET EM1 | 47.25 |
| surfactant | Versamul NS | 0.22 |

Preparation involves thorough mixing of the liquid ingredients and sonication to assist the dispersion of the dry ingredients. Final mixing of the iron particles was achieved using a high shear mixer (Silverson) for 20 mins at 6000RPM.

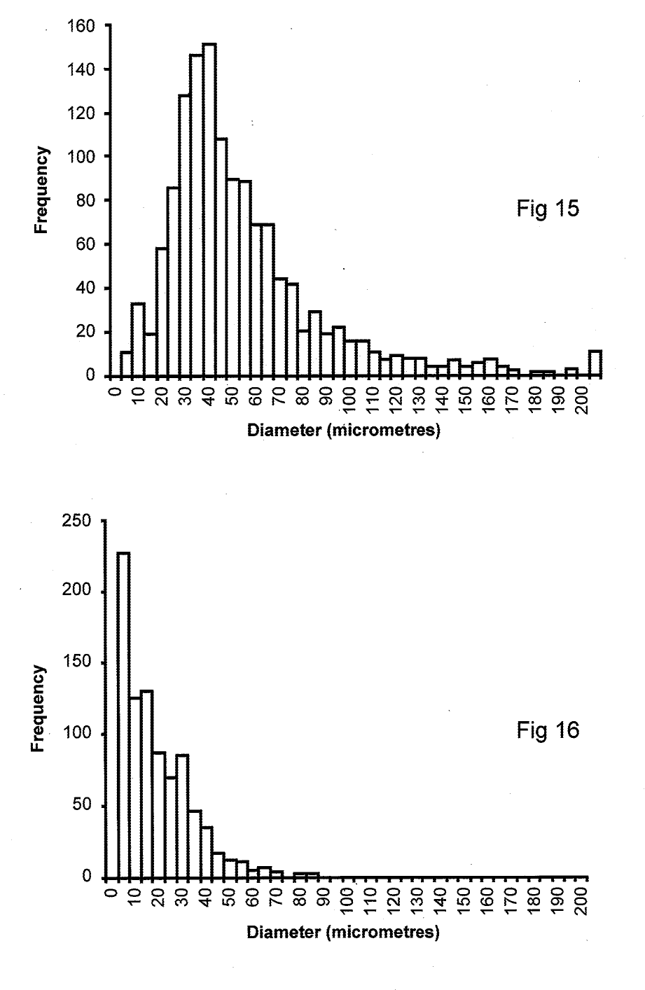

The resulting composition was immiscible in both water and oil. An emulsion of the composition in hydrocarbon oil (Clarisol 370) was prepared by mixing in a high shear Silverson mixer for 10 mins at 2000 RPM. The dispersed droplets of the photocurable composition, containing iron particles, ranged in size from 5 to 200 microns as determined by microscope image analysis. (FIG. 15).

Iron has a high specific gravity (7.1) and it was observed that droplets containing the larger iron particles settled from the emulsion, but only over a period of time. After three days from emulsion preparation the particle size distribution was re-measured revealing that particles larger than 50 microns had mostly settled out but the smaller particles were still in suspension (FIG. 16). Using gravimetric measurements of a 5 mL volume sample of the emulsion, the density of the remaining dispersed droplets was determined and the iron particle content in these dispersed droplets was calculated as 1.71%±0.09% by volume and 12.14%±0.6% by weight.

Although it is possible to incorporate a high weight percentage of iron, as in the composition above, we have found that a lower amount, such as 5 to 10 wt % allows better penetration of light to initiate curing of the composition, whilst enabling collection of particles by a magnetic field.

### Example 3

A laboratory experiment was carried out to demonstrate dispersion of droplets of magnetic photocurable composition in liquid and subsequent collection of them. As shown diagrammatically in FIG. 17, the apparatus consisted of a one litre Schott bottle fitted with an overhead stirrer 170 and an electromagnet 172 placed against the outside of the bottle.

A magnetic photocurable composition as prepared in the previous example was dispersed by stirring in hydrocarbon oil (Clarisol 370) in the bottle. The droplets 174 were observed to have a size of 1 to 3 mm and remained in suspension as stirring continued. However, when the electromagnet 172 was switched on, the droplets 174 of photocurable resin, with the iron powder still inside the droplets, rapidly clustered into one mass against the wall of the bottle as shown at 176.

It will be appreciated that the example embodiments described in detail above can be modified and varied within the scope of the concepts which they exemplify. Features referred to above or shown in individual embodiments above may be used together in any combination as well as those which have been shown and described specifically. Accordingly, all such modifications are intended to be included within the scope of this disclosure as defined in the following claims.

1. A method of applying a photocurable coating to a downhole fixed surface surrounding the axis of a wellbore containing a wellbore fluid, the method comprising
placing a downhole tool with at least one applicator in the wellbore;
traversing the at least one applicator over the downhole surface while supplying a photocurable liquid composition between the applicator and the downhole surface thereby spreading the composition as a curable layer on the downhole surface;
providing a light output with a light-transmitting barrier facing and adjacent the curable layer on the downhole surface; and
directing light of wavelength in a range from 100 nm to 1500 nm through the light-transmitting barrier onto the curable light-transmitting barrier so as to initiate curing of the layer on the downhole surface.

2. A method according to claim 1 wherein the curable layer extends more than three quarters the distance between the barrier and the downhole surface.

3. A method according to claim 1 wherein the light-transmitting barrier is in direct contact with the curable layer on the downhole surface.

4. A method according to claim 2 wherein the light-transmitting barrier has a fluorocarbon at its surface in contact with the curable layer.

5. A method according to claim 1 further comprising introducing a layer of light-transmitting liquid, which does not undergo photocuring, between the barrier and the curable layer.

6. A method according to claim 1 wherein the curable composition, either alone or together with light transmitting liquid, bridges the distance from the barrier to the downhole surface.

7. A method according to claim 1 or wherein the downhole fixed surface is the wall of an open-hole wellbore.

8. A wellbore tool for applying a photocurable coating to a fixed downhole surface surrounding the axis of a wellbore wherein the tool comprises
at least one applicator comprising a light-transmitting barrier to face a downhole surface surrounding the wellbore tool;
means to move the applicator over the downhole surface;
means to deliver a photocurable liquid composition to enter between the applicator and the downhole surface, and
at least one light output configured to direct light through the light transmitting barrier towards the downhole surface.

9. A method of applying a photocurable coating to a downhole fixed surface surrounding the axis of a wellbore containing a fluid, the method comprising
placing in the wellbore a downhole tool comprising at least one applicator which is an assembly comprising light-transmitting material and support means for positioning an area of the light transmitting material facing the downhole surface;
moving the assembly over the downhole surface while supplying a photocurable composition to enter between the area of light transmitting material and the downhole surface, the said area of light transmitting material being in contact with curable composition between the light transmitting material and the downhole surface and with any movement of the said area of light transmitting material relative to the downhole surface being slower than the movement of other parts of the applicator assembly relative to the downhole surface; and
directing light of wavelength in a range from 100 nm to 1500 nm through the area of light transmitting material onto the curable composition so as to initiate curing of the composition between the area of light transmitting material and the downhole surface.

10. A method according to claim 9 wherein the support means comprises a pair of rotary elements spaced one from another and the light transmitting material is a belt running in a continuous loop over these rotary elements.

11. A method according to claim 10 wherein the assembly comprises a light output positioned between the rotary elements and within the loop of the belt so that it can direct light through the said portion of the belt.

12. A method according to claim 9 wherein the light transmitting material is a continuous band at the surface of a deformable roller.

13. A method according to claim 9 wherein the photocurable liquid composition is supplied as droplets in the wellbore fluid, the droplets containing magnetisable material, and the method comprises collecting the droplets with a magnetic field so that collected droplets enter between the applicator and the downhole surface.

14. A wellbore tool for applying a photocurable coating to a downhole surface surrounding the axis of a wellbore wherein the tool comprises
at least one applicator which is an assembly which comprises light-transmitting material and support means for positioning an area of light transmitting material facing the downhole surface;
means to deliver a photocurable liquid composition to enter between the web and the downhole surface
means for moving the assembly over the downhole surface with any movement of the said an area of light transmitting material relative to the downhole surface being slower than movement of other parts of the applicator assembly relative to the downhole surface, and
at least one light output configured to direct light through the said an area of light transmitting material towards the downhole surface.

15. A wellbore tool according to claim 14 wherein the support means comprises a pair of rotary elements spaced one from another and the light transmitting material is a belt running in a continuous loop over these rotary elements.

16. A wellbore tool according to claim 15 wherein the light output is positioned between the rotary elements and within the loop of the belt so that it can direct light through the said stationary portion of the belt.

17. A wellbore tool according to claim 13 wherein the light transmitting material is a band of material at the surface of a roller and the light output is within the roller.

18. A wellbore tool according to claim 8 wherein the at least one applicator includes one or more light emitting diodes to provide the light output.

19. A wellbore tool according to claim 8 wherein the tool comprises a light source and a fibre optic cable to carry light to the at least one applicator.

20. A wellbore tool according to claim 8 comprising means to move the at least one applicator outwardly towards and inwardly from said fixed downhole surface.

21. A wellbore tool according to claim 8 comprising at least one magnet to collect droplets of photocurable liquid composition containing magnetisable material from the wellbore fluid.
